(19) United States
(12) Patent Application Publication
(10) Pub. No.: US 2020/0141649 A1
(43) Pub. Date: May 7, 2020

(54) OVEN SYSTEM HAVING A HOT AIR HEATING

(71) Applicant: EBNER INDUSTRIEOFENBAU GMBH, Leonding (AT)

(72) Inventors: Werner LUZ, Kaarst (DE); Robert EBNER, Leonding (AT)

(21) Appl. No.: 16/611,471

(22) PCT Filed: May 9, 2018
(86) PCT No.: PCT/EP2018/061948

§ 371 Date: Nov. 6, 2019

(30) Foreign Application Priority Data
May 11, 2017 (DE) 10 2017 110 273.6

(51) Int. Cl. F27B 9/30; C22F 1/04; C21D 9/56

(52) U.S. Cl. CPC F27B 9/3005; C21D 9/56; C22F 1/04

(57) ABSTRACT

The present invention describes an oven system for temperature-controlling a metal component (101), in particular an aluminium strip. The oven system has a first temperature-control section (110) for temperature-controlling the metal component at a first temperature, a second temperature-control section (120) for temperature-controlling the metal component at a second temperature, and a temperature-control device (102) for temperature-controlling a temperature-control fluid. The first temperature-control section (110) and the second temperature-control section (120) are configured such that the metal component (101) is conveyable between the first temperature-control section (110) and the second temperature-control section (120). The first temperature-control section (110) has a first fluid inlet having a first control valve (111) for controlling a fluid flow of the temperature-control fluid into the first temperature-control section (110). The second temperature-control section (120) has a second fluid inlet having a second control valve (121) for controlling a fluid flow of the temperature-control fluid into the second temperature-control section (120). The temperature-control device (102) is coupled to the first control valve (111) and the second control valve (121), such that a first fluid flow of the temperature-control fluid into the first temperature-control section (110) and a second fluid flow of the temperature-control fluid into the second temperature-control section (120) are controllable.

### CROSS-REFERENCE TO RELATED APPLICATIONS

The present application is a national phase application derived from the International Patent Application No. PCT/EP2018/061948, filed May 9, 2018, which claims the benefit of the filing date of the German Patent Application No. DE 10 2017 110 273.6, filed May 11, 2017, the disclosures of which are incorporated herein by reference in their entireties.

### TECHNICAL AREA

The present invention relates to an oven system, and a method, for temperature-controlling a metal component, in particular an aluminium strip.

### BACKGROUND OF THE INVENTION

In the manufacture of metal components and in particular of metal strips, these are intentionally temperature-controlled in a continuous reheating furnace, in order to set a desired metal bond structure in the final product. Herein, metal components or metal strips are guided continuously or sequentially through individual sections of the continuous reheating furnace. The individual sections of the continuous reheating furnace can be heated individually at a defined temperature. The metal component to be temperature-controlled is subjected to a pre-defined course of temperature during the running through of the continuous reheating furnace, such that a desired metal structure is adjustable.

Sealing a continuous reheating furnace in particular at its input and output regions is difficult, because generally, the metal components to be temperature-controlled are continuously guided in and out through openings. Furthermore, the individual sections have to be delimited precisely in respect of their temperature between the individual sections of the continuous reheating furnace, such that a desired temperature can be adjusted in the corresponding sections energy-efficiently.

### PRESENTATION OF THE INVENTION

There may be a need to provide an oven, which has plural temperature-control sections, and each temperature-control section is adjustable energy-efficiently.

The invention provides an oven system and a method for temperature-controlling a metal component, in particular an aluminium strip or a non-ferrous metal strip, according to the subjects of the independent patent claims.

According to an exemplary embodiment of the invention, there is provided an oven system (for example an annealing furnace) for temperature-controlling a metal component, in particular an aluminium strip or a non-ferrous metal strip. The oven system has a first temperature-control section for temperature-controlling the metal component at a first temperature, a second temperature-control section for temperature-controlling the metal component at a second temperature and a (in particular one single central) temperature-control device for temperature-controlling a temperature-control fluid (for example hot air or cooling air). The first temperature-control section and the second temperature-control section are configured such that the metal component is conveyable between the first temperature-control section and the second temperature-control section. The first temperature-control section has a first fluid inlet having a first control valve for controlling a fluid flow of the temperature-control fluid into the first temperature-control section. The second temperature-control section has a second fluid inlet having a second control valve for controlling a fluid flow of the temperature-control fluid into the second temperature-control section. The temperature-control device is coupled to the first control valve and the second control valve, such that a first fluid flow of the temperature-control fluid into the first temperature-control section and a second fluid flow of the temperature-control fluid into the second temperature-control section are controllable.

According to a further exemplary embodiment the invention, there is provided a method for temperature-controlling a metal component, in particular an aluminium strip or a non-ferrous metal strip. The method has a temperature-controlling of the metal component at a first temperature in a first temperature-control section, and a temperature-controlling of the metal component at a second temperature in a second temperature-control section, wherein the metal component is conveyed between the first temperature-control section and the second temperature-control section. The method further has a controlling of a fluid flow of a temperature-control fluid into the first temperature-control section by a first control valve at a first fluid inlet of the first temperature-control section, and a controlling of a fluid flow of a temperature-control fluid into the second temperature-control section by a second control valve at a second fluid inlet of the second temperature-control section. The temperature-control fluid is temperature-controlled by a (in particular one single central) temperature-control device. The temperature-control device is coupled to the first control valve and/or the second control valve, such that a first fluid flow of the temperature-control fluid into the first temperature-control section and/or a second fluid flow of the temperature-control fluid into the second temperature-control section can be controlled.

The oven system according to the present invention may be configured in particular as an oven system according to the type of a continuous reheating furnace. For example, the oven system may be configured according to the type of a floating strip furnace (or gas cushion-type strip supporting furnace). According to a continuous reheating furnace, the metal component to be tempered and/or a metal strip may be carried continuously or sequentially along a conveying direction through the oven (or furnace). During the carrying through the oven, the metal component may pass by different temperature-control sections one after the other.

The first temperature-control section and the second temperature-control section may be arranged for example one behind the other in the conveying direction of the metal component. The first temperature-control section may for example be adjustable to a first temperature and the second temperature-control section may be adjustable to a second temperature. According to the described oven system, a plurality of further temperature-control sections, for example eight to 30 temperature-control sections, in particular 14 temperature-control sections, may be arranged one behind the other in the conveying direction. The temperature-control sections may be formed by a common oven housing, which may be configured thermally insulated with respect to the environment of the oven system. Each temperature-control section accordingly may have an input, through which the metal component may be carried in (or introduced), and an output, through which the metal component may be carried out (or guided out).

Each temperature-control section may have at its input and/or at its output for example a contact-less transition, through which the metal component may be carried in and carried out. Furthermore, the temperature-control sections may be configured modularly and be mounted and/or coupled exchangeably to neighbouring temperature-control sections. Accordingly, the number of the temperature-control sections in the conveying direction may be adapted selectively.

Each temperature-control section may have for example corresponding conveying devices for conveying the metal component. The conveying devices may form e.g. groups of nozzles, in order to convey the metal component, e.g. the aluminium strip, floatingly. The transition between the temperature-control sections may be effected e.g. floatingly, i.e. contact-less.

Furthermore, a corresponding re-circulating blower device may be arranged in a temperature-control section, in order to re-circulate temperature-control fluid, which may serve for temperature-controlling the metal component, in the temperature-control section, such that a homogeneous temperature-control effect of the metal component may be effected.

The temperature-control sections may function as heating zones or as cooling zones. As a heating zone, the metal component may be heated in the corresponding temperature-control section, and as a cooling zone, the metal component may be cooled in the corresponding temperature-control section. In an exemplary embodiment, a temperature between 400° C. and 1000° C., in particular between 450° C. to 600° C., may be adjusted in a temperature-control section as a heating zone. In an exemplary embodiment, a temperature between 50° C. and 600° C., in particular between 250° C. and 500° C., may be adjusted in a temperature-control section as a cooling zone.

The metal component may be formed for example as a metal circuit board and/or a metal element, and may respectively be present completely in a temperature-control section. An according metal element may for example be conveyed sequentially between the temperature-control sections. Furthermore, the metal component may be a strip-shaped (or band-shaped) element and/or a metal strip, which may be carried (or guided) for example in the conveying direction through the temperature-control sections. Accordingly, one region of the metal strip, respectively, may be temperature-controlled in one temperature-control section. In particular, an aluminium strip or a non-ferrous metal strip as a metal component may be temperature-controlled advantageously with the present invention.

Furthermore, the first temperature-control section and the second temperature-control section, respectively, may have a fluid inlet. A temperature-control fluid, for example hot air or cooling air, may be blown into the interior of the corresponding temperature-control section through the corresponding fluid inlet.

The temperature-control fluid may have, for example beside air, also another gas mixture, for example an inert gas or a burner gas. A control valve may be arranged accordingly in the first fluid inlet and/or in a second fluid inlet. According to the control valve, the fluid flow (i.e. the volume flow) into the interior of each temperature-control section may be controlled.

Accordingly, a temperature-control power, i.e. a cooling power or a heating power, may be adjusted in each temperature-control section. Furthermore, a temperature change may be performed quickly in a temperature-control section with a higher fluid flow. The respective control valves may be controlled for example by a central control unit. The control valves may be embodied for example as control flaps and/or ventilation flaps, which may be adjustable e.g. via a servomotor.

The temperature-control fluid may be temperature-controlled by a temperature-control device. The control valves and/or the fluid inlets may be coupled to the temperature-control device. Thus, the temperature-controlled temperature-control fluid may be provided to all temperature-control sections centrally via one central supply conduit (or supply pipeline). A desired temperature-control power and/or a desired temperature may be adjusted in the respective temperature-control sections via an individual supply of the temperature-control fluid into the corresponding temperature-control sections by the control of the control valves.

The temperature-control device may have a gas burning device, a circulating air blower (or fan) (having heating elements, such as for example a resistance heating, or cooling elements) and/or an electro-heating battery (or register). Furthermore, the temperature-control device may represent a cooling device, which may cool a temperature-control fluid.

Thus, with the oven system according to the invention, a temperature-control fluid may be temperature-controlled centrally with e.g. one single temperature-control device, and subsequently be distributed targetedly individually to the plural temperature-control sections. Herein, it may no longer be necessary that the individual temperature-control sections have individual temperature-control units. Nevertheless, in an exemplary embodiment, the temperature-control sections may respectively have individual temperature-control units for providing a base temperature, wherein the detailed adjustment of the temperature in the temperature-control sections may be adjusted by the supply of the temperature-control fluid through the corresponding control valves. Thus, a desired temperature may be adjusted in the temperature-control sections energy-efficiently.

According to an exemplary embodiment, the first temperature-control section may have a first fluid outlet for flowing out the temperature-control fluid out of the first temperature-control section. Herein, the inflowing temperature-control fluid may push, so to say, the temperature-control fluid that may be located already in the temperature-control section out of the temperature-control section.

According to an exemplary embodiment, the first fluid outlet may have a further first control valve for controlling a fluid flow of the temperature-control fluid out of the first temperature-control section. Herein, the further first control valve may control in particular a volume flow out of the temperature-control section. Thereby, for example, an overpressure in the atmosphere of the temperature-control section relative to the environment may be established, so that an inflow of surrounding air into the temperature-control section may be prevented. The further control valves may be embodied for example as hot air flaps. The further control valve may thus adapt the outlet flow of the temperature-control fluid to the inlet volume flow of the temperature-control fluid. The further control valve may be operable manually or automatically, for example pneumatically, hydraulically or electrically.

According to a further exemplary embodiment, the temperature-control device may be coupled to the first fluid outlet, such that a fluid circuit flow of the temperature-control fluid may be generatable. In other words, the temperature-control device may use the temperature-control fluid, which may have been tapped out of the corresponding temperature-control sections, again, in order to adjust the temperature-control fluid to a desired temperature. Thus, the temperature-control fluid may need to be heated or cooled typically over a smaller temperature-control region as compared to a case where a temperature-control fluid may be used for example from the surroundings.

According to a further exemplary embodiment, the second temperature-control section may have a second fluid outlet for flowing out the temperature-control fluid out of the second temperature-control section. According to a further exemplary embodiment, the second fluid outlet may have a further second control valve for controlling a fluid flow of the temperature-control fluid out of the second temperature-control section. According to a further exemplary embodiment, the temperature-control device may be coupled to the second fluid outlet, such that a fluid circuit flow of the temperature-control fluid may be generatable. In other words, the possibility may exist that one central back-guiding conduit may be provided, to which the temperature-control sections with the corresponding fluid outlets may be coupled. Thus, for example, a temperature-control circulation may be established, in which the temperature-control fluid may be blown in from the temperature-control device via a common supply conduit (or supply pipeline) into the corresponding temperature-control sections, and in which the temperature-control fluid may be conveyed out of the corresponding temperature-control sections through a common discharge conduit (or discharge pipeline) to the temperature-control device. Furthermore, a part of the back-guided temperature-control fluid may be tapped out of the discharge conduit via an exhaust air conduit described below and be supplied to the surroundings (e.g. via a filter and/or a chimney). Thus, a pressure equilibration of the temperature-control fluid may be established between the supply conduit and the discharge conduit. For example, in the case of a gas burner as the temperature-control device, additional temperature-control fluid may be introduced into the circulation due to the burner gas, and a pressure equilibration may be established in the back-guiding conduit by tapping-off.

According to a further exemplary embodiment, the oven system may further have a temperature sensor, which is arranged between the first fluid outlet and the temperature-control device, such that a temperature of the temperature-control fluid, which may flow out of the first fluid outlet, may be measurable. Correspondingly, also further temperature sensors may be arranged between the further fluid outlets of the further temperature-control devices. Thus, a defined supply of temperature-control fluid to the temperature-control device may be controlled precisely.

According to a further exemplary embodiment, the oven system may further have a further temperature-control device for temperature-controlling the temperature-control fluid (or a further temperature-control fluid) at a second temperature. The temperature-control device and/or the further temperature-control device may be coupleable selectively to the first control valve and/or the second control valve. For example, the first temperature-control device may serve as a heating device for heating the temperature-control fluid, and the further temperature-control device may serve as a cooling device for cooling the temperature-control fluid. Thus, a desired temperature-control fluid may be provided at a defined temperature precisely and quickly selectively for one and the same temperature-control section, or for different temperature-control sections. For example, two circulations with two temperature-control fluids may be provided, wherein one temperature-control fluid may be temperature-controlled by the temperature-control device, and be supplied to two or more temperature-control sections, and another temperature-control fluid may be temperature-controlled by the further temperature-control device and may be supplied to two or more temperature-control sections. One of the temperature-control fluids may be supplied to one and/or two or more defined temperature-control sections as a function of the desired temperature.

According to a further exemplary embodiment, the oven system may further have a volume flow sensor (e.g. a Venturi valve and/or Venturi pipe), which may be arranged between the temperature-control device and the first fluid inlet, such that a volume flow of the temperature-control fluid, which may flow through the first fluid inlet, may be measurable. Correspondingly, a corresponding volume flow sensor may be built in the second fluid inlet or in the further fluid inlets of the further temperature-control sections. The volume flow of the temperature-control fluid, which may flow into or out of the corresponding temperature-control sections, may be measured precisely by the volume flow sensor. The information from the volume flow sensor may be provided at the disposition of the respective control valves, in order to adjust the control valve precisely.

According to a further exemplary embodiment, the oven system may further have an exhaust air conduit for dissipating the temperature-control fluid out of the first temperature-control section and/or the second temperature-control section to a surroundings of the oven system. Thus, for example a temperature-control fluid, which may have been already dissipated or received heat energy in a temperature-control section, may be dissipated to the surroundings. For example, also only a part of the temperature-control fluid, which may have been dissipated by the temperature-control sections, may be dissipated to the exhaust air conduit, while another part of the temperature-control fluid may be supplied anew to the temperature-control device.

According to a further exemplary embodiment, the oven system may further have a heat exchanger, which may be coupled to the temperature-control device and the exhaust air conduit, such that heat may be exchanged, by the heat exchanger, between the temperature-control fluid, which may have been dissipated out of the first temperature-control section and/or the second temperature-control section, and a temperature-control fluid, which may be supplied to the temperature-control device. Thus, for example, a fresh temperature-control fluid may be supplied to the temperature-control sections, wherein a consumption of the temperature-control fluid may dissipate or receive the heat to/from the fresh temperature-control fluid. Thus, an exchange of the temperature-control fluid in the temperature-control circulation may be performed energy-efficiently.

By the present invention, a heat power or a cooling power may centrally be introduced into the individual oven zones and/or temperature-control zones by the (e.g. single) temperature-control device, whereby an energy reduction up to 50% may be possible, because the heat consumption in the temperature-control sections may be shifted 1:5. The energy demand per temperature-control section may better be adapted by the central supply of temperature-control fluid (for example hot air heating). Furthermore, for example, a quick cooling of the oven recirculation air may be possible, whereby a higher oven zone temperature may be operated in the temperature-control sections.

Furthermore, the temperature-control fluid may be adjusted at a temperature of above 720° C., such that the hydrocarbons may be cleaned via a thermal oxidation by a “thermal grease removal”. Thus, the temperature-control fluid may be cleaned from organic substances. In summary, by the oven system according to the invention, a lower energy demand may be enabled by the use of a central temperature-control device (for example, a central burner and/or electro-heat exchanger). Furthermore, a quick cooling or a quick heating may be provided by the air guiding system (i.e. the temperature-control fluid guiding system). Also, the recirculation air/dissipation air may be cleaned according to the anti-pollution law more simply from present organic residues via a central dissipation of the temperature-control fluid in a central dissipation conduit.

The heat withdrawal may be very different in the individual oven sections as a function of the annealing process parameters. For the hot air heating according to the invention, the power to be installed (only one heat source, temperature-control device) may be designed for the total process. The energy demand may be controlled comfortably via the hot air flaps (control valves, further control valves). In the hot air heating according to the invention, the oven sections may be cooled quickly by 300° K and more by a large volume of cold air in the case of a conveyor stop (EMERGENCY STOP). The recirculation air temperature of the oven may then be lowered for example to 450° C. in ca. 30 s. The metal strip (metal component) then may not become softy (flexible) and may not tear (or rip) upon a new conveyor start.

Furthermore, for example rolling oils may be present on a metal strip as a metal component, which may volatilize at temperatures between 180° C. and 450° C. The rolling oil residues may amount definitely to 10 μm per side. These volatile rolling oils may, after a vaporization, be present in the recirculating air circulation of the oven air atmosphere. By the hot air heating according to the invention, a large air exchange per oven section may be effectuated. The recycling hot air may, according to the invention, subsequently be brought to a temperature of e.g. 720° C. in the central heat source (temperature-control device). At temperatures above 720° C., the hydrocarbons, which may be present due to the thermal grease removal of the rolling oils, may oxidize in the atmosphere, such that a temperature increase may be generated. This additional heat may be beneficial to the total energy consideration, such that the external energy supply may be reduced.

After a retention time of 1 s, the hot air behind the central heat source (temperature-control device) (e.g. >720° C.) may be clean and may then be dissipated e.g. into the surroundings. Then, e.g. no harmful substance filter may be necessary.

It is pointed out that the embodiments described herein represent only a limited selection of possible embodiment variants of the invention. Thus, it is possible to combine the features of individual embodiments in a suitable manner, such that for the skilled person with the embodiment variants that are explicit herein, a plurality of different embodiments is to be considered as obviously disclosed. In particular, some embodiments of the invention are described by device claims and other embodiments of the invention by method claims. However, it will become immediately clear to the skilled person upon reading this application, that, unless it is explicitly indicated differently, in addition to a combination of features, which belong to one type of invention subject, also an arbitrary combination of features, which belong to different types of invention subjects, are possible.

### SHORT DESCRIPTION OF THE DRAWINGS

In the following, for a further explanation and for a better understanding of the present invention, embodiment examples are described in more detail with reference to the appended drawing.

FIG. 1 shows a schematic illustration of an oven system according to an exemplary embodiment example of the present invention.

### DETAILED DESCRIPTION OF EXEMPLARY EMBODIMENTS

Same or similar components in different figures are provided with same reference numerals. The representation in the figure is schematic.

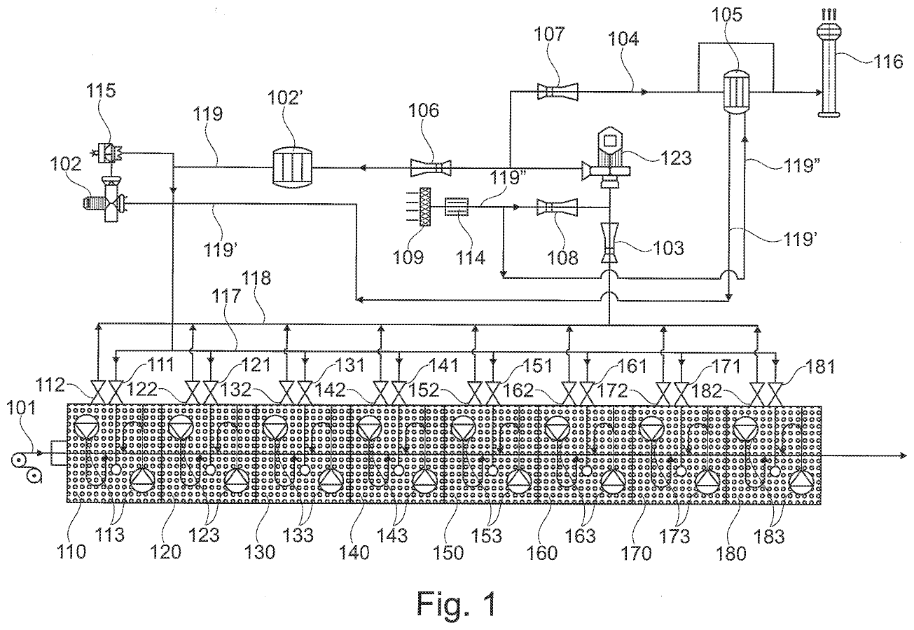

FIG. 1 shows an oven system for temperature-controlling a metal component 101, in particular an aluminium strip or a non-ferrous metal strip. The oven system may have a first temperature-control section 110 for temperature-controlling the metal component at a first temperature, a second temperature-control section 120 for temperature-controlling the metal component at a second temperature, and a temperature-control device 102 for temperature-controlling a temperature-control fluid. The first temperature-control section 110 and the second temperature-control section 120 may be configured such that the metal component 101 may be conveyable between the first temperature-control section 110 and the second temperature-control section 120. The first temperature-control section 110 may have a first fluid inlet having a first control valve 111 for controlling a fluid flow of the temperature-control fluid into the first temperature-control section 110. The second temperature-control section 120 may have a second fluid inlet having a second control valve 121 for controlling a fluid flow of the temperature-control fluid into the second temperature-control section 120. The temperature-control device may be coupled to the first control valve 111 and the second control valve 121, such that a first fluid flow of the temperature-control fluid into the first temperature-control section 110 and a second fluid flow of the temperature-control fluid into the second temperature-control section 120 may be controllable.

The oven system may be formed according to the type of a continuous reheating furnace. During the passing through the oven system, the metal component 101 may pass by different temperature-control sections 110 to 180 one after another.

The first temperature-control section 110 and the second temperature-control section 120 may be arranged for example one behind the other in a conveying direction of the metal strip 101. The first temperature-control section 110 may be for example adjustable to a first temperature and the second temperature-control section 120 to a second temperature. According to the described oven system in FIG. 1, for example eight temperature-control sections may be arranged one behind the other in the conveying direction. The temperature-control sections 110 to 180 may be formed by a common oven housing, which may be formed thermally insulated with respect to the surroundings of the oven system. Each temperature-control section 110 to 180 may have, respectively, an inlet, through which the metal component 101 may be carried in, and an outlet, through which the metal component 101 may be carried out.

Each temperature-control section 110 to 120 may have at its inlet and/or at its outlet for example a temperature-insulating positing system (or sluice), for example an aerodynamical positing system, through which the metal component 101 may be carried in and carried out.

The temperature-control sections 110 to 180 may be formed modularly and may be attached and/or coupled replaceably to neighbouring temperature-control sections 110 to 180. Accordingly, the number of the temperature-control sections 110 to 180 in the conveying direction may be adapted selectively.

Furthermore, a corresponding recirculating blower (or recirculating fan) 113 to 183 may be arranged in the temperature-control section 110 to 180, respectively, in order to recirculate a temperature-control fluid, which may serve for temperature-controlling the metal component 101, in the corresponding temperature-control section 110 to 180, in order to effectuate a homogeneous temperature-control effect on the metal component 101.

The temperature-control sections 110 to 180 may function as heating zones or as cooling zones. In an exemplary embodiment, a temperature between 550° C. to 800° C. may be adjusted in a temperature-control section as a heating zone. In an exemplary embodiment, a temperature between 250° C. to 500° C. may be adjusted in a temperature-control section as a cooling zone.

By the corresponding fluid inlets, the temperature-control fluid, for example as heating air or cooling air, may be blown into the interior of the corresponding temperature-control section 110 to 180. In the first fluid inlet and/or a second fluid inlet, a control valve 111 to 181 may be arranged, respectively. The fluid flow (i.e. the volume flow) of the temperature-control fluid into the interior of each temperature-control section 110 to 180 may be controlled by the control valves 111 to 181. Accordingly, a temperature-control power, i.e. a cooling power or a heating power, may be adjusted in each temperature-control section 110 to 180. The respective control valves 111 to 181 may be controlled for example by a central control unit.

The temperature-control fluid may be temperature-controlled by a central temperature-control device 102. The control valves 111 to 181 and/or the fluid inlets may be coupled to the temperature-control device 102. Thus, the temperature-controlled temperature-control fluid may be provided to all temperature-control sections 110 to 180 centrally via a central supply conduit 117. A desired temperature-control power and/or a desired temperature in the respective temperature-control sections may be adjusted by the control of the control valves 111 to 181 via an individual supply of the temperature-control fluid into the corresponding temperature-control sections 110 to 180.

The temperature-control device may have a gas burner 102, a recirculating blower (having heating elements, such as for example a resistance heating, or cooling elements) and/or an electro-heating battery (or register) 102′. Furthermore, the temperature-control device may represent a cooling device, which may cool a temperature-control fluid.

Furthermore, the temperature-control sections 110 to 180 may have corresponding fluid outlets for flowing out the temperature-control fluid. Further control valves 112 to 182 may be arranged accordingly at the corresponding fluid outlets. Herein, the inflowing temperature-control fluid may push, so to say, out of the temperature-control section 110 to 180 the temperature-control fluid that may be located already in the temperature-control section 110 to 180.

The further control valves 112 to 182 may control in particular a volume flow out of the temperature-control sections 110 to 180. Thus, for example, an overpressure in the atmosphere of the temperature-control section 110 to 180 with respect to the surroundings may be established, such that an inflow of air from the surroundings into the temperature-control section 110 to 180 may be prevented.

The temperature-control device 102 may be coupled to the fluid inlets of the corresponding temperature-control sections 110 to 180 via the central supply conduit 117. Furthermore, the temperature-control device 102 may be coupled to the corresponding outlets of the corresponding temperature-control sections 110 to 180 via the central discharge conduit (or discharge pipeline) 118, such that a fluid circuit of the temperature-control fluid may be generatable. In other words, the temperature-control device 102 may use the temperature-control fluid, which may be tapped from the corresponding temperature-control sections 110 to 180, anew (or again), in order to adjust the temperature-control fluid to a desired temperature. Thus, the temperature-control fluid typically may have to be heated or cooled over a smaller temperature-control range as compared to a case when a temperature-control fluid may be used for example from the surroundings.

For example, a temperature-control sensor may be arranged at the corresponding fluid outlets, in order to thus measure the temperature of the temperature-control fluid flowing out of the respective temperature-control sections 110 to 180. According temperature sensors may also be arranged at the respective fluid inlets of the temperature-control sections 110 to 180.

In the exemplary embodiment in FIG. 1, alternative temperature-control devices 102, 102′ are represented by way of example. The temperature-control devices 102, 102′ may form alternatives or may be switched in series one behind the other. Furthermore, in an exemplary embodiment, a further temperature-control device 102, 102′ for temperature-controlling the temperature-control fluid at a second temperature may be formed. The temperature-control devices 102, 102′ then may feed selectively and separately from each other a corresponding temperature-controlled temperature-control fluid into the central supply conduit 117. For example, the first temperature-control device 102, 102′ may serve as a heating device for heating the temperature-control fluid, and the further temperature-control device may serve as a cooling device for cooling the temperature-control fluid. Thus, a desired temperature-control fluid having a defined temperature may precisely and quickly be supplied selectively for the temperature-control section 110 to 180.

Furthermore, a volume flow sensor 103 may be provided in the discharge conduit 118 for a better control of the circuit of the temperature-control fluid. The volume flow of the temperature-control fluid, which may flow out of the temperature-control sections 110 to 180, may be measured precisely by the volume flow sensor 103. Correspondingly, a volume flow sensor 103 may be arranged in the supply conduit 117, such that a volume flow, which may flow into the corresponding temperature-control sections 110 to 180, may be measured. The information from the volume flow sensors 103 may be put at the disposition of the respective control valves 111 to 181, in order to precisely adjust the corresponding control valve 111 to 181.

The oven system further may have an exhaust air conduit 104 for removing the temperature-control fluid out of the temperature-control sections 110 to 180. Thus, for example, a temperature-control fluid, which may have already given away or received heat energy in a temperature-control section 110 to 180, may be emitted to the surroundings. For example, also only a part of the temperature-control fluid, which may have been emitted from the temperature-control sections 110 to 180, may be emitted to the exhaust air conduit 104, while another part of the temperature-control fluid may be supplied to the temperature-control device 102 anew (or again). For example, the exhaust air may be emitted through a chimney 116.

Furthermore, the oven system may have a heat exchanger 105, which may be coupled to the temperature-control device 102 via a supply conduit 119′ and to the supply conduit 119″ such that heat may be exchangeable, by the heat exchanger 105, between the temperature-control fluid, which may b e carried away from the temperature-control sections 110 to 180 by the exhaust air conduit 104, and a temperature-control fluid, which may be supplied to the temperature-control device 102.

A fresh temperature-control fluid may be brought from the surroundings for example via an air inlet 109 into the oven system. For example, air from the surroundings may be supplied as a temperature-control fluid via a filter in the air inlet 109. Furthermore, a sound absorber 114 may be provided in the oven system before the introduction for noise reduction. The new temperature-control fluid may be carried to the corresponding temperature-control device 102 for example in a supply conduit 119. The supplied new temperature-control fluid may have in particular a temperature from −5° C. to 45° C. The new temperature-control fluid may be mixed with the temperature-control fluid that may be already recirculating in the circulation, in order to adjust a desired temperature. For example, the temperature fluid behind the gas burner 102 may have a temperature of above 1000° C. Thus, by the newly added temperature-control fluid, for example air from the surroundings from the supply conduit 119″, a temperature-control fluid having a temperature of, for example, 700° C. may be adjusted. A combustion air 115 of the gas burner may for example be blown out or may be used as a temperature-control fluid.

Furthermore, the new temperature-control fluid may be sucked in via the air inlet 109, in order to enable a quick cooling via the sucked-in fresh air. The sucked-in temperature-control fluid may also be supplied via the central supply conduit for example directly into the corresponding temperature-control sections 110 to 180 for a quick cooling. The degree of the quick cooling may be measured for example by the volume flow sensor 108.

Furthermore, the new temperature-control fluid may be supplied to the heat exchanger 105 by the supply conduit 119″, and may be heated by the dissipated heat from the temperature-control fluid from the exhaust air conduit 104. Subsequently, the heated new temperature-control fluid may be supplied from the heat exchanger 105 to the temperature-control device 102 by the supply conduit 119′.

For example, a blower 123 may be arranged in the central discharge conduit 118 and/or the supply conduit 119, in order to adjust the circulation of the temperature-control fluid.

Supplementarily, it should be noted that “having” (or “comprising”) does not exclude other elements or steps, and that “a” or “an” does not exclude a plurality. Furthermore, it should be noted that features or steps, which have been described with reference to one of the embodiment examples above, can also be used in combination with other features or steps of other embodiment examples described above. Reference numerals in the claims are not to be considered as a limitation.

### LIST OF REFERENCE NUMERALS

| | |
|---|---|
| 101 | metal component |
| 102 | temperature-control device/gas burner |
| 102′ | electro-heating battery |
| 103 | volume flow sensor |
| 104 | exhaust air conduit |
| 105 | heat exchanger |
| 106 | volume flow sensor |
| 107 | volume flow sensor |
| 108 | volume flow sensor |
| 109 | air inlet/fresh air |
| 110 | first temperature-control section |
| 111 | first control valve |
| 112 | further first control valve |
| 113 | recirculation blower |
| 114 | sound absorber |
| 115 | combustion air |
| 116 | chimney |
| 117 | central supply conduit |
| 118 | central discharge conduit |
| 119 | supply conduit to |
| | temperature-control device |
| 120 | second temperature-control section |
| 121 | second control valve |
| 122 | further second control valve |
| 123 | blower |
| 130 | third temperature-control section |
| 131 | third control valve |
| 132 | further third control valve |
| 140 | fourth temperature-control section |
| 141 | fourth control valve |
| 142 | further fourth control valve |
| 150 | fifth temperature-control section |
| 151 | fifth control valve |
| 152 | further fifth control valve |
| 160 | sixth temperature-control section |
| 161 | sixth control valve |
| 162 | further sixth control valve |
| 170 | seventh temperature-control section |
| 171 | seventh control valve |
| 172 | further seventh control valve |
| 180 | eighth temperature-control section |
| 181 | eighth control valve |
| 182 | further eighth control valve |

1-14. (canceled)

15. Oven system for temperature-controlling a metal component, in particular a metal strip, the oven system having:
a first temperature-control section for temperature-controlling the metal component at a first temperature,
a second temperature-control section for temperature-controlling the metal component at a second temperature,
wherein the first temperature-control section and the second temperature-control section are configured such that the metal component is conveyable between the first temperature-control section and the second temperature-control section,
wherein the first temperature-control section has a first fluid inlet having a first control valve for controlling a fluid flow of a temperature-control fluid into the first temperature-control section,
wherein the second temperature-control section has a second fluid inlet having a second control valve for controlling a fluid flow of the temperature-control fluid into the second temperature-control section, and
a temperature-control device for temperature-controlling the temperature-control fluid, wherein the temperature-control device is coupled to the first control valve and the second control valve, such that a first fluid flow of the temperature-control fluid into the first temperature-control section and a second fluid flow of the temperature-control fluid into the second temperature-control section are controllable.

16. Oven system according to claim 15,
wherein the first temperature-control section has a first fluid outlet for flowing out the temperature-control fluid out of the first temperature-control section.

17. Oven system according to claim 16,
wherein the first fluid outlet has a further first control valve for controlling a fluid flow of the temperature-control fluid out of the first temperature-control section.

18. Oven system according to claim 16,
wherein the temperature-control device is coupled to the first fluid outlet, such that a fluid circuit flow of the temperature-control fluid is generatable.

19. Oven system according to claim 18, further having
a temperature sensor, which is arranged between the first fluid outlet and the temperature-control device, such that a temperature of the temperature-control fluid, which flows out from the first fluid outlet, is measurable.

20. Oven system according to claim 15,
wherein the second temperature-control section has a second fluid outlet for flowing out a fluid flow of the temperature-control fluid out of the second temperature-control section.

21. Oven system according to claim 20,
wherein the second fluid outlet has a further second control valve for controlling a fluid flow of the temperature-control fluid out of the second temperature-control section.

22. Oven system according to claim 20,
wherein the temperature-control device is coupled to the second fluid outlet, such that a fluid circuit flow of the temperature-control fluid is generatable.

23. Oven system according to claim 15, further having
a further temperature-control device for temperature-controlling the temperature-control fluid at a second temperature,
wherein the temperature-control device and the further temperature-control device are coupleable selectively to the first control valve and/or the second control valve.

24. Oven system according to claim 15,
wherein the temperature-control device has a gas burning device having a combustion air ventilator, a circulating air blower and/or an electro-heating battery.

25. Oven system according to claim 15, further having
a volume flow sensor, which is arranged between the temperature-control device and the first fluid inlet, such that a volume flow of the temperature-control fluid, which flows in through the first fluid inlet, is measurable.

26. Oven system according to claim 15, further having
an exhaust air conduit for discharging the temperature-control fluid out of the first temperature-control section and/or the second temperature-control section.

27. Oven system according to claim 26, further having
a heat exchanger, which is coupled to the temperature-control device and the exhaust air conduit, such that heat is exchangeable, by the heat exchanger, between the temperature-control fluid, which is discharged out of the first temperature-control section and/or the second temperature-control section and a temperature-control fluid, which is supplied to the temperature-control device.

28. Method for temperature-controlling a metal component, in particular an aluminium strip, the method having
temperature-controlling the metal component at a first temperature in a first temperature-control section,
temperature-controlling the metal component at a second temperature in a second temperature-control section,
wherein the metal component is conveyed between the first temperature-control section and the second temperature-control section,
controlling a fluid flow of a temperature-control fluid into the first temperature-control section by a first control valve at a first fluid inlet of the first temperature-control section,
controlling a fluid flow of a temperature-control fluid into the second temperature-control section by a second control valve at a second fluid inlet of the second temperature-control section,
temperature-controlling the temperature-control fluid by a temperature-control device,
wherein the temperature-control device is coupled to the first control valve and the second control valve, such that a first fluid flow of the temperature-control fluid into the first temperature-control section and a second fluid flow of the temperature-control fluid into the second temperature-control section can be controlled.
